(19) United States
(12) Patent Application Publication
(10) Pub. No.: US 2024/0400203 A1
(43) Pub. Date: Dec. 5, 2024

(54) Automated Aircraft Management System

(71) Applicant: Textron Aviation Inc., Wichita, KS (US)

(72) Inventors: Tony Garrett Gregorovic, Derby, KS (US); Michael Allen Bullard, Wichita, KS (US)

(21) Appl. No.: 18/677,852

(22) Filed: May 29, 2024

Related U.S. Application Data
(60) Provisional application No. 63/505,209, filed on May 31, 2023.

(51) Int. Cl. B64D 11/00; B64F 5/60; G06N 3/04; G06V 20/59; G06V 40/10; G06V 40/20

(52) U.S. Cl. CPC B64D 11/00; B64F 5/60; G06N 3/04; G06V 20/59; G06V 40/10; G06V 40/20

(57) ABSTRACT

An automated aircraft management system having a machine learning model configured to receive inputs and output an aircraft analysis. The inputs can be inputs from users adjusting aircraft settings, sensor data collected from a variety of sensors detecting aircraft parameters, and historical data from a user profile. The aircraft analysis can include adjustments to apply to the aircraft and anomalies which may provide indication of a faulty aircraft system.

### CROSS REFERENCE TO RELATED APPLICATIONS

This application claims the benefit of U.S. Provisional Patent Application No. 63/505,209, filed May 31, 2023, and the entire contents thereof are herein incorporated by reference.

### BACKGROUND

### 1. Field

Embodiments of the disclosure relate generally to automated aircraft management systems and, more specifically, to automated systems that monitor and manage aircraft systems.

### 2. Related Art

Various solutions have been proposed for anticipating the needs of a passenger seated in a seating area of a vehicle. For instance, anticipating passenger needs may be performed on a mobile platform, such as a train, marine vessel, aircraft, or automobile. These systems may include control modules that can move seats or tray tables. The controls can also activate/deactivate light sources and perform combinations thereof based on the activity data. Additionally, cabin service systems may control cabin audio systems, passenger and cabin lighting, and in-flight entertainment subsystems.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the disclosure will be apparent from the following detailed description of the embodiments and the accompanying drawing figures.

In some embodiments, the techniques described herein relate to a method for automated aircraft management, the method including: collecting sensor data from sensors associated with an aircraft; inputting information including the sensor data into a machine learning model for analysis; outputting, via the machine learning model, an aircraft analysis associated with the sensor data and the aircraft, where the aircraft analysis includes adjustments to mechanisms within the aircraft; and applying, at least in part, the adjustments from the aircraft analysis to the aircraft.

In some embodiments, the techniques described herein relate to a system for automated aircraft management, the system including: a detection component configured to detect parameters associated with an aircraft; a machine learning component configured to provide an aircraft analysis of at least the parameters detected by the detection component; and an adjustment component configured to adjust aircraft mechanisms associated with at least the aircraft analysis.

In some embodiments, the techniques described herein relate to a computer program product for automated aircraft management, the computer program product including a computer readable storage medium having computer readable instructions stored therein, wherein the computer readable instructions, when executed on a computing device, causes the computing device to: receive data associated with an aircraft, wherein the data includes sensor data from sensors associated with the aircraft: analyzing the aircraft by inputting the data into a machine learning model, wherein analyzing the aircraft includes adjustments to aircraft mechanisms; and implementing the adjustments to the aircraft.

### BRIEF DESCRIPTION OF THE DRAWING FIGURES

Embodiments of the disclosure are described in detail below with reference to the attached drawing figures, wherein:

FIG. 1 illustrates an overhead cabin view, in accordance with embodiments of the present disclosure.

FIG. 2 illustrates a partial view of a galley and storage compartments of an automated cabin environment, in accordance with embodiments of the present disclosure.

FIG. 3 illustrates a passenger bench seat of an automated cabin environment, in accordance with embodiments of the present disclosure.

FIG. 4 illustrates a passenger seat of an automated cabin environment, in accordance with embodiments of the present disclosure.

FIG. 5 illustrates a side ledge, and tables of an automated cabin environment, in accordance with embodiments of the present disclosure.

FIG. 6 illustrates a partial view of a vanity of an automated cabin environment, in accordance with embodiments of the present disclosure.

FIG. 7 illustrates a system for having an automated aircraft management system on accordance with embodiments of the present disclosure.

FIG. 8 illustrates a diagram of an exemplary machine learning calculation model used to calculate an aircraft analysis in the automated aircraft management system.

FIG. 9 illustrates a data flow chart for having the automated aircraft management system.

FIG. 10 illustrates a process flow chart for having the automated aircraft management system.

FIG. 11 illustrates a use case sequence diagram for having the automated aircraft management system.

FIG. 12 illustrates a block diagram of an exemplary computing device, in accordance with embodiments of the present disclosure.

The drawing figures do not limit the disclosure to the specific embodiments disclosed and described herein. The drawings are not necessarily to scale; emphasis is instead placed upon clearly illustrating the principles of the disclosure.

### DETAILED DESCRIPTION

The following detailed description references the accompanying drawings that illustrate specific embodiments in which the disclosure can be practiced. The embodiments are intended to describe aspects of the disclosure in sufficient detail to enable those skilled in the art to practice the disclosure. Other embodiments can be utilized, and changes can be made without departing from the scope of the disclosure. Therefore, the following detailed description is not to be taken in a limiting sense. The scope of the disclosure is defined only by the appended claims and the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

This disclosure relates generally to automated aircraft management systems and, more specifically, to methods and systems that predict passenger interaction with components and systems located within an aircraft using various sensors. The following description is directed to some particular examples for the purpose of describing innovative aspects of this disclosure. However, a person having ordinary skill in the art will readily recognize that the teachings herein can be applied in a multitude of different ways.

### Overview

Embodiments disclosed herein provide a control system and a method for having an automated aircraft management system, which gathers data on how an individual interacts with an aircraft using various sensors, and provides monitoring with real-time feedback. Preprogrammed cabin settings and machine learning can be utilized by a control system for aircraft analysis and to adjust mechanisms that enhance a passenger experience within the aircraft. Additionally, features of the automated aircraft management system may decrease the aircraft on ground (AOG) by preemptively notifying the status of systems and components before failure and directing maintenance workers to failure points, thereby decreasing troubleshooting times. Additionally, selectable protocols, among others, can be automated without the need for manual intervention.

Various aspects of the disclosure improve existing technologies, as well as others, by providing methods, components, and systems that support the automated management of an aircraft. Improvements to cabin customization and aircraft analysis technologies are described in embodiments herein and include using a machine learning model and user specific inputs to analyze aircraft diagnostics and apply adjustments to aircraft systems. Embodiments of the disclosure also include a control system configured to continuously manage an aircraft using a plurality of sensors disposed throughout the aircraft and cabin.

In some embodiments, a control system is able to identify individuals within the aircraft cabin. For instance, the control system may use radio frequency identification (RFID), a wireless network such as wireless fidelity (Wi-Fi), virtual private network (VPN), or near field communication (NFC), Bluetooth pairing, or an application accessed on a user device to identify an individual. In some implementations, the control system may identify an individual through the use of a camera equipped with image recognition technology. The control system can then record and store user information for the individuals detected by the sensors. User information, as it is collected, can be stored as historical data in a user profile for each individual.

In some implementations, input data fed into the control system may include information relating to settings and parameters that may control the environment within the aircraft cabin. For instance, the input data may include readings from a device detecting temperature, lighting, humidity, or other environmental parameters. Additionally, as another example, other information such as contact, pressure, and switch sensing devices may be disposed in the cabin to detect user interactions with components such as gallies, vanities, seats, window shades, and the like. Other detection devices, such as motion-sensitive and/or stationary cameras, may also contribute readings that are fed as input data to the control system.

In some embodiments, the control system is communicatively connected to sensors and cameras within the cabin to process and store information. When a sensor detects an activity or an environmental parameter, the control system can use machine learning techniques to analyze the data and produce an aircraft analysis. The aircraft analysis can recommend adjustments to aircraft components and/or environmental parameters within the aircraft cabin. Those recommendations can then be implemented in the aircraft.

In some embodiments, the adjustments include having the control system set an environmental parameter within the aircraft cabin. For example, sensor detection information, such as temperature, is detected when a user input specifies a cabin temperature. The control system can store this temperature information in a user profile and preset the cabin temperature to the user's preferred temperature when the user is identified, as described above. In some implementations, the control system is configured such that historical data is stored to correspond to a time of year and/or time of day for increased customization to the preset temperature.

In some embodiments, the aircraft analysis includes having the control system detect an anomaly. In embodiments, an anomaly may be an indication that a task requires attention. For instance, the control system may be able to predict when an aircraft air supply system needs maintenance. In this particular instance, the control system is able to use sensor information possibly collected from an air quality or temperature sensor to provide indications of the status of air onboard an aircraft to determine when personnel may be required to check the air supply system.

As such, particular aspects of the subject matter described in this disclosure can be implemented to realize one or more of the following potential advantages. The present disclosure aims to allow automated management to improve and enhance a user experience in the cabin of an aircraft by implementing mechanisms that manage components and environmental parameters while providing continuous monitoring and feedback of aircraft systems. By providing continuous feedback, embodiments can analyze the information gathered and apply adjustments based on input data. This allows embodiments to monitor and customize an aircraft and aircraft cabin for an individual and limit AOG. As such, being able to automate the management of an aircraft cabin improves a user experience and allows aircraft personnel to be more efficient.

### Example Automated Aircraft Cabin Environment

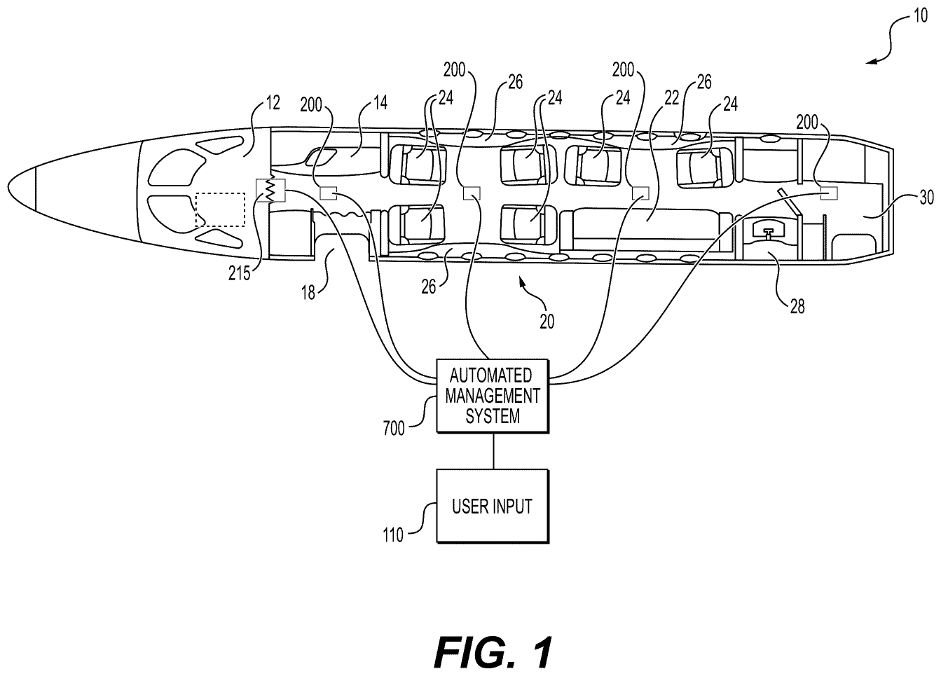

FIGS. 1-6 provide an environment of an example automated aircraft cabin environment 20. FIG. 1 shows an overhead view of an aircraft 10 and environment 20, including automated management capabilities for use in implementing embodiments of the disclosure. The automated aircraft cabin environment 20 includes a cockpit 12 with a galley 14, a cabin door 18, a cabin 20 with passenger bench seating 22, passenger seats 24, side ledges and tables 26, a vanity 28, and a restroom 30. A plurality of sensors 200 associated with various components within the automated environment 20 are connected via various modes of data transmission, including wireless, discrete, recommended standard (RS)-232, RS-485, Bluetooth, or Aeronautical Radio Inc. (ARINC) protocol, and the like. In embodiments, sensors 200 can include various different types of sensing instruments including, but not limited to, contact, pressure, temperature, micro-switch, motion, and proximity sensors disposed throughout the aircraft 10. The term “sensor” or “sensors” as used within this application may include any type of instrument configured to sense a parameter within and around the aircraft 10 or automated environment 20.

In some embodiments, with reference to FIG. 1, contact sensors may be disposed in the aisleway of aircraft 10, but may be disposed anywhere within aircraft 10. Motion-sensitive cameras 215 are disposed to monitor the automated environment 20 of the aircraft 10, and may be configured with image recognition technology to identify person(s) within environment 20. Sensors 200 and cameras 215 are configured to collect data, which may be transmitted to a machine learning model, described below in connection with FIGS. 7-11 to provide an automated aircraft management system. The machine learning model may collect, store, and analyze the data collected from sensors 200 and cameras 215 to improve the efficiency of designs, features, maintenance schedules, diagnostic and development of future products, and improve user experience. The aircraft automated management system is further configured to use machine learning to identify usage trends and schedules when a user interacts with the aircraft 10.

The automated aircraft management capabilities of the automated cabin environment 20 can be implemented as a standalone system or as part of another system or suite of systems used in the management, operation, and maintenance of an aircraft. For example, the automated management capabilities can be implemented as part of a suite of support services, enabling the automated management to be a module of an aircraft services system.

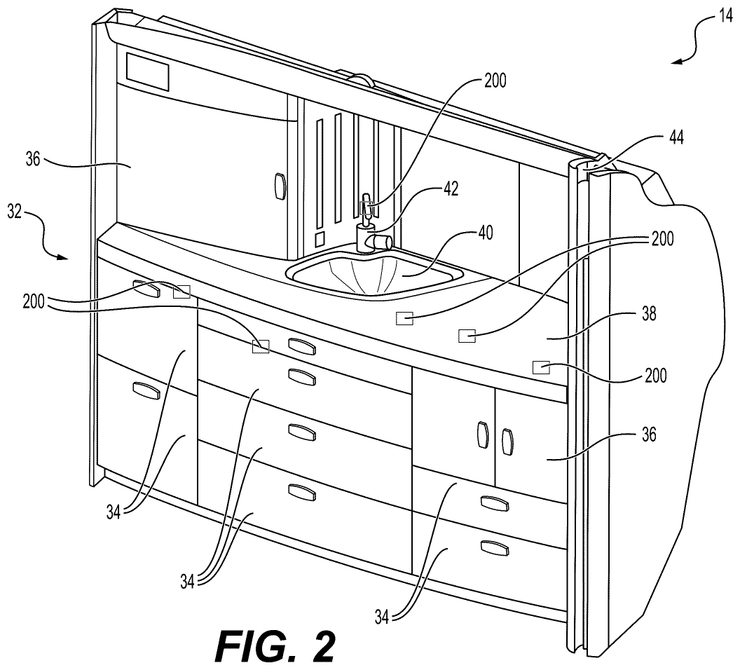

FIG. 2 illustrates a partial view of a galley and storage compartments 14 of the automated management environment 20 in embodiments. The galley 14 includes a cupboard 32 with a plurality of drawers 34, cabinets 36, a counter 38, a sink 40 and faucet 42, and a folding door 44 to close off and secure the galley 14 as desired. Sensors 200 include momentary micro switches that may be incorporated into the cupboard 32 to monitor the drawers 34 and cabinets 36 and to detect which drawers 34 and cabinets 36 are used, opened, closed, and their duration of use. Motion (e.g., ultrasonic) sensors may be used to monitor foot traffic and positions of individuals proximate to the cupboard 32. Contact detection sensors, such as capacitive sensors may be incorporated into the surface of the counter 38 (shown in FIG. 2), drawers 34, and cabinets 36 to monitor and record when and how an individual interacts with the galley 14. Pressure and strain sensors may be incorporated into the surfaces of the counter 38 (shown in FIG. 2), shelves in the cabinets 36, and drawers 34 to monitor usage and loads. For example, if a strain sensor in a drawer 34 can indicate that there is no load, that may mean the drawer 34 is empty. Lighting and faucet 42 operations may be controlled by capacitive touch, gesture sensors, or other means such that usage of water and lighting is monitored and may be effectively managed. Temperature sensors may be incorporated into the faucet 42 or cabinets 36 to detect the temperature of water flowing from faucet 42 and provide temperature control within cabinets 36. Additionally, temperature sensors may be used in occupied spaces as well as baggage and storage areas.

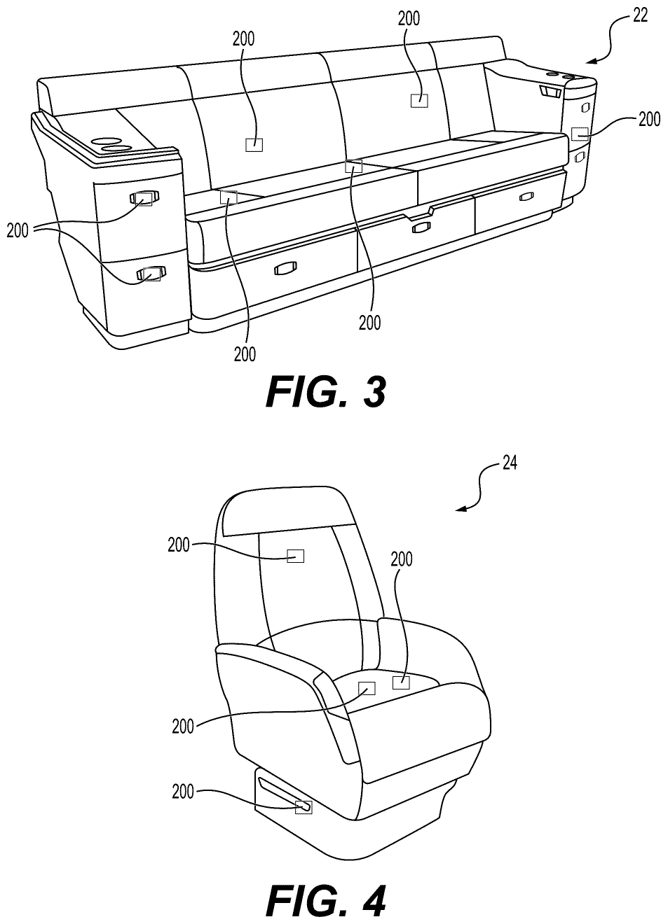

FIGS. 3 and 4 illustrate passenger and crew seating of the automated environment 20 in embodiments. The passenger and crew seating may include sensors 200, such as pressure/strain sensors to indicate when a seat is occupied, and inductive and proximity sensors to sense the position of the seat and position relative to the location in the environment 20 or cockpit. Capacitive/contact sensors may be incorporated into handles, paddles, seat belt buckles, seats, and other surfaces to monitor touch points. Contact sensors may be incorporated into other locations in the automated environment 20 to detect interference with cabin structure and other obstacles such as baggage. Momentary microswitches may be integrated into the seating to detect when drawers are used, when handles are operated, and when other associated amenities are used. Temperature sensors may be integrated into the seating to recognize biological presence and record the preferences of individual passengers and crew. Contact sensors may be integrated into the seating to detect interference with cabin structures or other obstacles such as baggage.

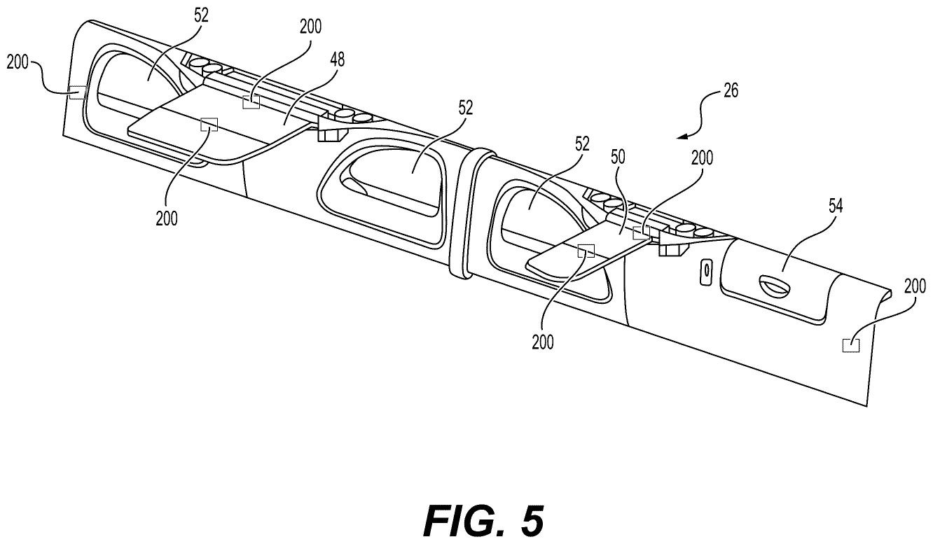

FIG. 5 illustrates a side ledge and tables 26 of the automated environment 20. Side ledge and tables 26 in embodiments include one or more fold-out side tables 48 and 50, storage areas 52, and storage compartment 54. Sensors 200, such as momentary micro switches, may be incorporated into side tables 48 and 50 to monitor use position and the duration of use. Proximity sensors may be used to monitor passengers proximate to the side tables 48 and 50. Contact detection sensors, such as capacitive sensors may be incorporated into a surface of the side tables 48 and 50 and within the storage areas 52 and storage compartment 54 to monitor and record when and how an individual is using these features.

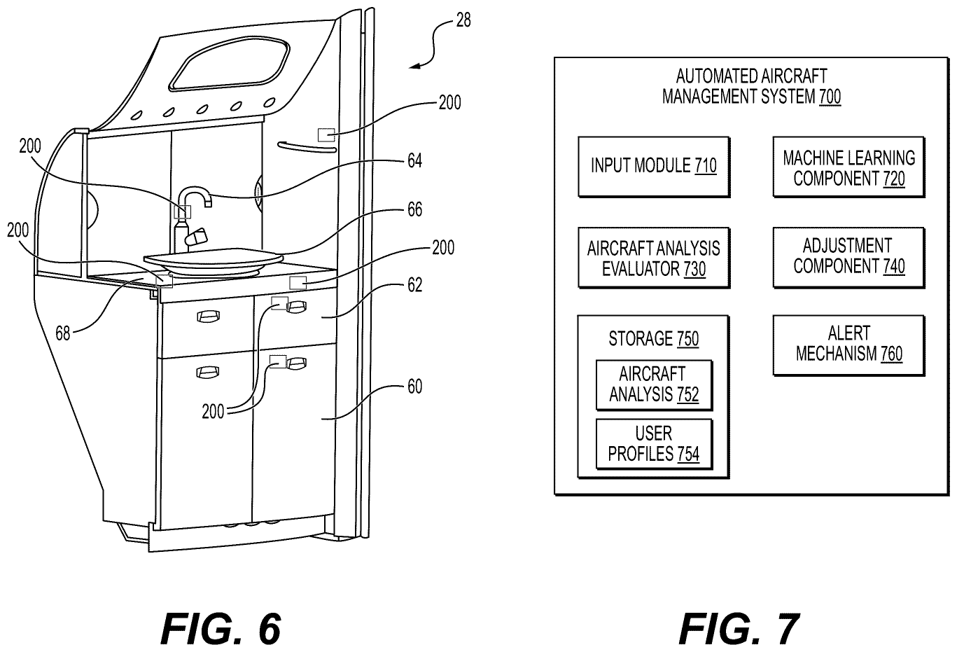

FIG. 6 illustrates a partial view of an exemplary vanity 28 of the automated environment 20, which includes a cabinet 60, drawers 62, a faucet 64, and a sink 66. Momentary microswitches may be incorporated into the vanity 28 to monitor the drawers 62 and cabinet 60 to detect which drawers 62 and cabinet 60 are used, opened, closed, and the duration of use. Sensors 200, such as ultrasonic/motion sensors, may be used to monitor foot traffic and positions of crew and passengers proximate to the vanity 28. Contact detection sensors, such as capacitive sensors, may be incorporated into the surface of the counter 68, drawers 62, and cabinet 60 to monitor and record when and how a user is using the vanity 28. Pressure and strain sensors may be incorporated into the surfaces of the counter 68, shelves in the cabinet 60, and drawers 62 to monitor usage and loads. Lighting and faucet 64 operations may be controlled by capacitive touch sensors. Temperature sensors may be incorporated into the faucet 64 to monitor the preferred water temperatures of a particular user.

In some embodiments, a baggage/cargo storage area may be equipped with sensors. Pressure and strain sensors may be incorporated into the surfaces of cubbies and shelves to monitor usage and loads and to allow the machine learning model to detect when baggage/cargo has shifted during flight, possibly requiring attention. Temperature sensors may be incorporated into the baggage/cargo storage to monitor preferred temperatures for a particular article of baggage/cargo.

### Example Automated Aircraft System

Referring now to FIG. 7, a block diagram of an example automated aircraft management system 700 suitable for use in implementing embodiments of the disclosure is shown. The automated aircraft management system 700 is configured to predict passenger interaction with components and systems located within an aircraft using various sensors as well as predict anomalies that may occur to components associated with the aircraft. The automated aircraft management system 700 can utilize sensor data, historical data, and passenger input, in conjunction with machine learning techniques, to predict settings and/or anomalies associated with the aircraft and provide those predictions within an aircraft analysis. Using the aircraft analysis, the automated aircraft management system 700 can implement changes to the settings and take corrective actions to address potential anomalies occurring to the aircraft.

The automated aircraft management system 700 includes an input module 710, a machine learning component 720, an aircraft analysis 730, an adjustment component 740, storage 750, and an alert mechanism 760. In embodiments, the automated aircraft management system 700 acts on the automated environment 20.

In some embodiments, input module 710 includes collected data from the sensors 200 (and possibly camera 215) to provide the machine learning component 720 with information about the automated cabin environment 20, such as temperature, humidity, and lighting. Input module 710 may include user inputs received by an individual to adjust mechanisms in the aircraft. For instance, a user input may be a command to adjust a mechanism controlling cabin temperature or lighting. Input module 710 may include sensor readings corresponding to an activity. For example, an activity detected by sensors 200 may be a user interacting with an aircraft galley or adjusting an aircraft seat. Input module 710 may include sensor readings corresponding to aircraft diagnostics including an air supply, electrical, or mechanical system. A sensor reading may be indicative of maintenance required on the aircraft.

The machine learning component 720 is a component of the automated aircraft management system 700 configured to identify patterns and make predictions about desirable cabin environment settings, maintenance, predictive diagnostics, and usage data, each of which may be optimized for an identified user or group of users. For example, the machine learning component 720 may use machine learning algorithms to learn which combinations of temperature, humidity, and lighting levels are most likely to create a comfortable and relaxing atmosphere for passengers (e.g., for passengers in general and for specific individual passengers).

In embodiments, machine learning component 720 calculates an aircraft analysis 752 which identifies adjustments able to be made to aircraft systems. In some embodiments, aircraft analysis 752 is based on input module 710. In some embodiments, the aircraft analysis 752 can include using adjustment component 740 to make adjustments to aircraft systems, detecting anomalies or conditions, and adding data to user profile 754.

The aircraft analysis evaluator 730 is a component of the automated aircraft management system 700 configured to analyze the aircraft analysis 752 and provide recommended adjustments and corrective actions based on the analysis. The aircraft analysis evaluator 730 may provide adjustments which may be used by adjustment component 740 aircraft settings in real-time.

The adjustment component 740 is a component of the automated aircraft management system 700 configured to adjust mechanisms, which can include adjusting thermostats, lighting mechanisms, and other controlling mechanisms to adjust aircraft systems.

In embodiments, storage 750 includes stored data, which may include stored aircraft analysis 752 and user profiles 754. In some embodiments, storage 750 includes historical data specific to individual users to provide customization to aircraft components and environments. For instance, user profile 754 can include user cabin temperature and lighting preferences and user activities in the aircraft and with aircraft components.

The storage 750, including stored aircraft analysis 752 and user profile 754, can provide historical data, including passenger behavior and cabin environment settings detected by the sensors 200 to create a dataset for machine learning component 720 to make computations.

In embodiments, alert mechanism 760 is configured to alert aircraft personnel. For instance, the alert may include notifying personnel of a predicted system failure or a task that may need to be attended to. For instance, as described above, machine learning component 720 may compute an anomaly or condition that requires attention, and the alert mechanism 760 notifies personnel of the condition or anomaly associated with aircraft analysis 730. For instance, a sensor reading input by input module 710 into machine learning component 720 may be associated by aircraft analysis 730 as being indicative of a faulty aircraft system. More specifically, the sensor reading may detect a lighting system, in which a detection could indicate an anomaly such as a faulty light bulb in the aircraft. The alert mechanism 760 can implement a corrective action notifying personnel to replace the faulty light bulb.

### Example of a Machine Learning Model

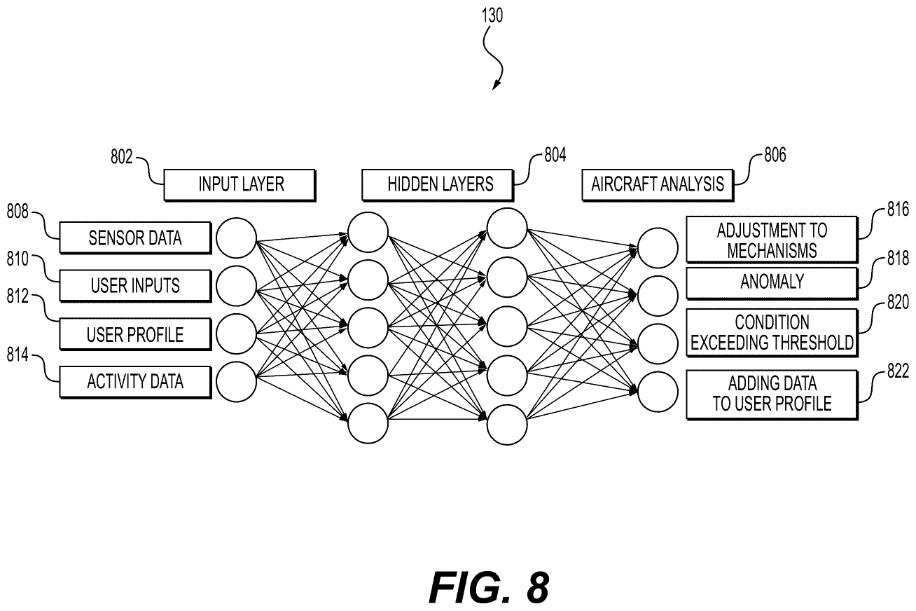

In embodiments, the machine learning component 720, or FIG. 7, can utilize a machine learning model/component as described below when making its predictions. In some embodiments with reference to FIG. 8, the machine learning model comprises neural network model 130 comprising an input layer 802, one or more hidden layers 804 (two are shown in FIG. 8), and an output layer being aircraft analysis 806. The input layer 802 is configured to receive inputs which can include sensor data 808, user inputs 810, user profile 812, and activity data 814.

In some embodiments, input data 802 includes collected data from the sensors 200 (and possibly camera 215) to provide the machine learning component with information about the automated cabin environment 20, such as temperature, humidity, and lighting. The input layer 802 may also be provided with the time of day and day of the year such that predictive user behaviors may be identified based on the time of day and the season of the year.

In some embodiments user inputs 810 may be received by an individual to adjust mechanisms in the aircraft. For instance, a user input 810 may be a command to adjust a mechanism controlling cabin temperature or lighting.

In some embodiments, user profile 812 is historical data of preferences associated with an identified user. The historical data can include a preferred temperature, lighting, entertainment settings, or other adjustable components of the aircraft. In some embodiments, activity data 814 can include passenger actions (e.g., detectable from motion, temperature, and/or load-based sensors 200).

In embodiments, the hidden layers 804 perform calculations on the input data from input layer 802 to provide output aircraft analysis 806. Hidden layers 804 can identify patterns and make predictions about desirable cabin environment settings, maintenance, predictive diagnostics, and usage data, each of which may be optimized for an identified user or group of users. For example, the hidden layers 804 may use machine learning algorithms to learn which combinations of temperature, humidity, and lighting levels are most likely to create a comfortable and relaxing atmosphere for passengers (e.g., for passengers in general and for specific individual passengers). To train the neural network model 130, the user historical data, including passenger behavior and cabin environment settings detected by the sensors 200 and stored in storage 750, is input to create a dataset for the neural network model 130 to make computations. The neural network model 130 may be trained using various machine learning algorithms, such as regression or classification, to identify a variety of patterns, such as optimal environment settings and potential maintenance issues, to provide personnel with information for possible preemptive measures. The trained neural network model 130 outputs aircraft analysis 806 for various features based on the user-generated inputs.

In embodiments, the aircraft analysis 806 can include making adjustments to aircraft mechanisms 816, detecting an anomaly 818, detecting a condition exceeding a threshold 820, and adding data to a user profile 822. The aircraft analysis 806 may provide adjustments that may be used to adjust aircraft settings in real-time.

In some embodiments, adjustments to mechanisms 816 can include adjusting thermostats, lighting mechanisms, and other controlling mechanisms to adjust aircraft systems.

In some embodiments, aircraft analysis 806 can include an anomaly 818. Anomaly 818 can be an abnormal reading detected by sensors 200. For instance, an anomaly 818 may be an indication of faulty equipment associated with the aircraft. When an anomaly 818 is output by aircraft analysis 806, an alert may be produced as described in relation to FIG. 7. In addition, the aircraft analysis 806 may also identify potential maintenance or diagnostic issues based on input data and make recommendations to maintenance personnel for preemptive repairs or replacements. Additionally, aircraft analysis 806 may be configured to detect if weight detected by a pressure sensor changes, which may be anomaly 818, indicating a drawer or cabinet needs to be restocked.

In some embodiments aircraft analysis 806 can include a detected condition that has exceeded a threshold 820. The hidden layers 804 can be configured to detect conditions, such as when a drawer, door, or cabinet is opened. In this way, the aircraft analysis 806 can detect when a condition is met a number of times that exceeds a threshold limit. This threshold limit may indicate that a drawer or cabinet needs to be restocked. In this instance, alert mechanism 760 is configured to produce an alert for personnel to refill the drawer as described in relation to FIG. 7. In this way, the aircraft analysis 806 can predict when the drawer may be empty in the future, such that a preemptive response to refill the drawer may be made.

In some embodiments, the aircraft analysis 806 includes adding data to a user profile 822. The user profile 822 includes historical data specific to individual users to provide customization to aircraft components and environments. For instance, user profile 822 can include user cabin temperature and lighting preferences and user activities in the aircraft and with aircraft components.

The neural network model 130 utilizes machine learning and input data for optimization of the aircraft which may lead to improved customer satisfaction and reduced maintenance costs. By using machine learning algorithms to identify patterns and make predictions based on user-generated inputs the neural network 130 allows automated aircraft management system 700 to provide a personalized experience for passengers while also identifying potential issues before they become problematic to possibly reduce the amount of time for aircraft maintenance.

### Example Flow Diagrams

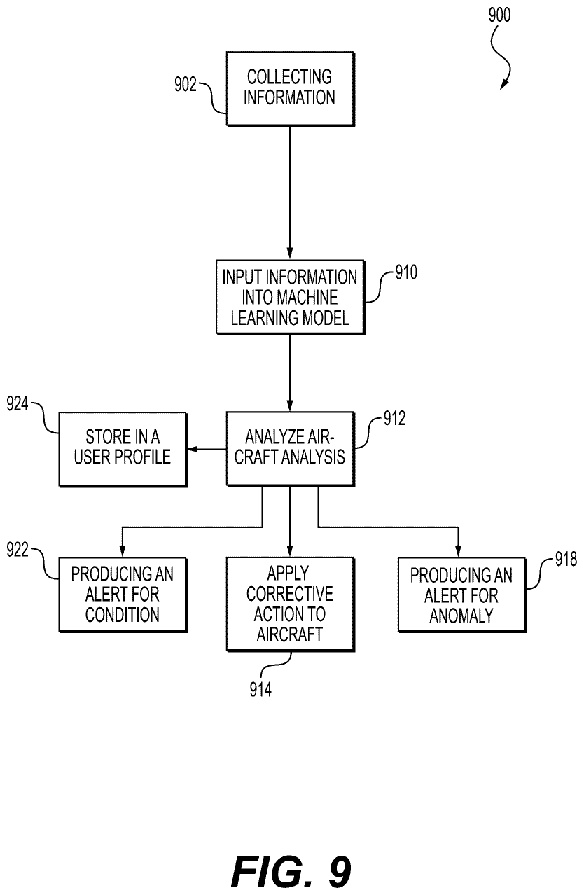

With reference to FIG. 9, a flow diagram is provided illustrating a method 900. Each block of the method 900 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media.

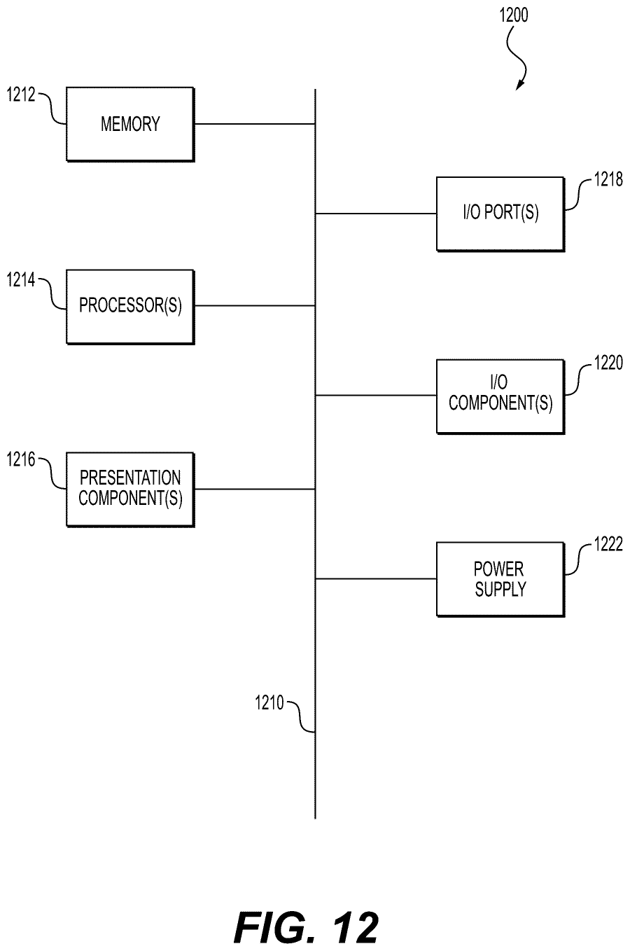

FIG. 9 illustrates a method 900 of a series of acts in a method of automated management of an aircraft, in accordance with embodiments of the present disclosure. In one or more embodiments, the method 900 is performed in an environment that includes the automated cabin environment 20. In some examples, the method 900 may be performed by a computing device such as the one of the computing device 1200, described with reference to FIG. 12. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes a block 902, which collects information associated with the aircraft 10. In some embodiments, the information collected includes sensor data from sensors disposed in and around the aircraft, user input, and user profiles having historical data associated with passengers.

In embodiments at block 902, input module 710 collects information and data relating to the aircraft and automated cabin environment from a detection component. The input module 710 includes a detection component having sensors 200 and the positioning of the various sensing instruments allows the detection component to gather data (e.g. sensor data) relating to the aircraft and aircraft cabin. In some examples, the collected sensor data from the sensors 200 include environmental parameters within the automated cabin environment 20 detected by the sensors 200.

In some examples, at block 902, the collected information includes user input associated with the aircraft. For example, the user adjusts/sets one or many environmental or component parameters within the automated environment 20. A user may input and adjust environmental parameters, such as the lighting or temperature, in the automated environment 20, and can input other information into the input module 710, which may include entertainment and hospitality settings. Input settings may additionally include adjusting an aircraft seat, controlling an audio level of an entertainment system, and raising and lowering window shades. A user may input information to the management system using a HMI on a compatible device, and/or press a button activating a mechanical system. In some embodiments the automated aircraft management system 700 may be equipped with voice recognition technologies for a user to adjust and input settings audibly.

In some examples, the collected information includes user profiles from passengers identified within the automated environment 20 of the aircraft by the automated aircraft management system 700. For instance, in block 902, a user may be identified when a user connects to the input module 710, which may be done in embodiments by using a network and/or an HMI as described above. A user profile 754, which corresponds to a user in the automated environment 20, may be combined with the sensor data at block 902. Identification of a user allows the machine learning component 720 to implement an environment catered to a specific individual. If an individual does not connect to the automated aircraft management system 700, the automated cabin environment can be monitored and automated using default baseline settings. A user profile can include information such as a user's preferred temperature and lighting settings, entertainment, or other sensor data collected while the user is in the cabin 20.

In some implementations, input module 710 may be supplied with information regarding a time of day and month such that user information correlating to daytime, nighttime, and seasons may be applied to better customize a user experience in the automated environment 20. In this implementation, the machine learning component 720 is configured to store user information in the user profile 754 corresponding to a time of day and/or season such that patterns and trends for a user can be established based on a time of day or season.

In some embodiments, input module 710 also receives inputs such as aircraft diagnostic information, such as a flight route, current location, airspeed, and pitch. The machine learning component 720 can use this information to determine an aircraft stage of flight and whether or not taxi-takeoff and landing (TTOL) protocols need to be initiated. TTOL procedures may include locking cabinets and drawers in a galley or vanity, raising window shades, dimming aircraft lighting, and displaying a fasten seat belt indicator. Safety protocols, such as whether or not a passenger is buckled in during the taxi-takeoff-and-landing phases of flight (TTOL) and other safety protocols may be automated by the automated aircraft management system 700 without the need for manual intervention or oversight. Other safety protocols may be carried out by automated aircraft management system 700 including but not limited to positioning electric seats and divider doors to ensure exits and egress paths are clear, and activating passenger safety ordinance signs (e.g., fasten seat belt, return to seat) which can be accompanied with an audible chime or pre-recorded announcement, for example.

At block 910, the collected information is inputted into a machine learning model (i.e. machine learning component 720).

At block 910, the machine learning component 720 inputs information into a machine learning model to output an aircraft analysis. In some examples, the machine learning component 720 uses the neural network model 130 to produce the aircraft analysis. In some implementations, at block 910, using the collected information, the machine learning component 720 uses calculations, machine learning, and/or artificial intelligence to output adjustments and detect anomalies with aircraft components. As data is collected, the machine learning component 720 can continuously receive information from the detection component regarding the aircraft and aircraft components and systems.

At block 912, an aircraft analysis 730 output by the machine learning component 720 at block 910 is analyzed. In embodiments, evaluating aircraft analysis 730 can include adjustments to mechanisms, predictive diagnostics, maintenance, automation, individual presets, and improved future innovation and design. For instance, an aircraft analysis evaluation 730 may include adjustments to mechanisms controlling the temperature, lighting, and/or other environmental parameters of the automated cabin environment 20. In some embodiments, evaluating aircraft analysis at block 912 includes sensors 200 detecting an activity. For example, an activity detected by sensors 200 may be a user interacting with an aircraft galley or adjusting an aircraft seat. Evaluation of aircraft analysis 730 may include when an aircraft cabin component such as a galley or vanity needs items restocked and/or when an aircraft seat needs replaced based on how often a user interacts with the galley/vanity and seat as recorded in the user profile 754. More specifically, aircraft analysis 730 evaluation can include when a drawer of a galley/vanity will need resupplied. For example, if a sensor 200, such as a strain sensor in a drawer 62 indicates that there is no load, then it may be determined that the drawer 62 is empty. In this way, the machine learning component 720 is able to analyze information regarding the amount of items the drawer is supplied with and how often the drawer needs restocked.

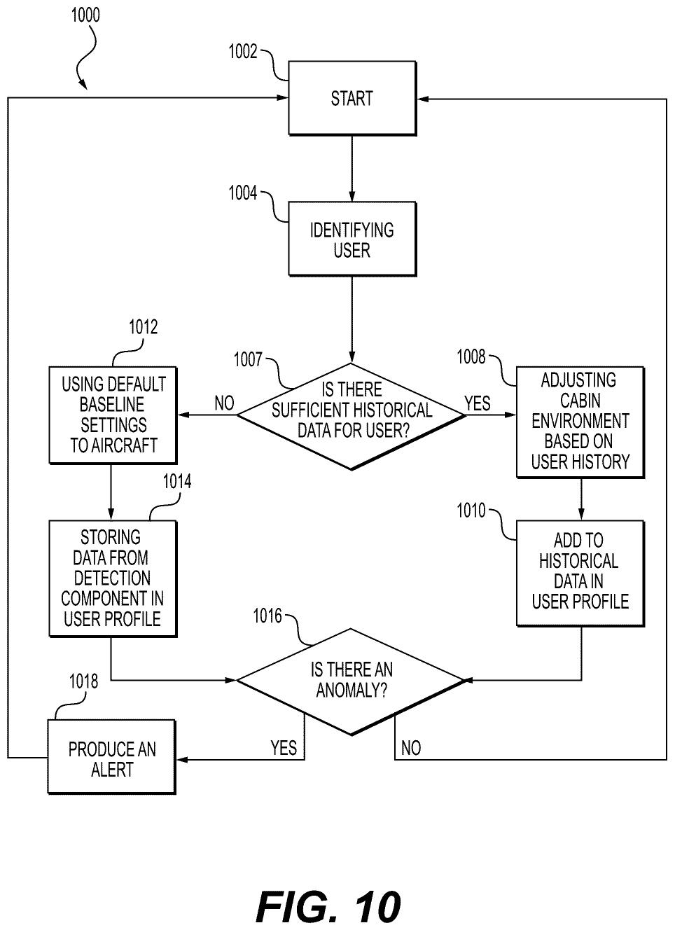

In some embodiments, evaluating the aircraft analysis at block 912 includes machine learning component 720 assessing the probability an outcome may happen by using calculation based on historical data, which can be in the user profile 754 or stored aircraft analysis 752. The historical data grows each instance a user is identified within the automated environment 20. This means that a user who has not used components in the automated environment 20 or contributed inputs 110 an adequate number of times to machine learning component 720 may have little or no historical data. In either of these instances, the machine learning component 720 defaults to baseline cabin settings (see FIG. 10) until an adequate amount historical data is available.

At block 914, machine learning component 720 applies corrective action identified in evaluating the aircraft analysis at block 912. In embodiments, machine learning component 720 is configured to communicate with aircraft systems and components (i.e. adjustment component 740) to provide autonomous control of the automated cabin environment 20 substantially providing a customized cabin experience for a user. In some embodiments, a corrective action includes the adjustment component 740 applying adjustments to control environmental changes to the automated environment 20 some of which can include temperature, humidity, and lighting changes, which may be done through communication to an aircraft air supply or electrical system. Additionally, the adjustment component 740 may communicate with mechanical systems to apply adjustments including lowering/raising window shades and controlling an aircraft seat position and orientation. Adjustment component 740 may also communicate with systems to apply adjustments to power, audio, and other settings for display and entertainment systems. In a specific instance, the machine learning component 720 may recognize a user position in an aircraft seat, and set the seat to an appropriate angle and/or temperature based on the information regarding a user interaction with the aircraft seat in a user profile.

In some embodiments, returning to block 912, evaluating aircraft analysis 730 includes detecting an anomaly with an aircraft component. For instance, an anomaly with an aircraft component may be an indication of faulty equipment within the aircraft. Components can include aircraft mechanical, electrical, or air supply systems. More specifically, if an aircraft air supply system is malfunctioning, sensors 200 would detect parameters associated with a malfunctioning air supply system and the machine learning model 720 can analyze the parameters in the aircraft analysis 730 and determine if the air supply system is malfunctioning.

When an anomaly is detected, the method 900 proceeds to block 918 in which an alert is produced with regard to the anomaly. In some implementations, machine learning component 720 preemptively notifies personnel the status of systems before failure and gives maintenance workers failure points, to decrease troubleshoot times. In some embodiments, an alert may be connected to an onboard network and have the ability to wirelessly transmit system notifications and alerts to maintenance and service centers (e.g., detailing a potential issue to be addressed once the aircraft has landed). Additionally, the automated aircraft management system 700 has the potential to submit usage reports that would define any potential issues or systems that will require scheduled maintenance.

In some embodiments, evaluating the aircraft analysis 730 at block 912 includes identifying when a condition has exceeded a predetermined threshold. For instance, sensors 200 may be configured to detect a condition and the aircraft analysis 730 indicates the number of times a condition has been met, and whether the number of times a condition is met has exceeded a threshold. More specifically, sensors 200 can detect a condition such as when a drawer is opened and closed. A threshold of the condition, i.e. the drawer opening, a specified number of times may be recognized by the aircraft analysis 730 and detected when the number of times the drawer is opened exceeds a threshold limit.

In some implementations, when the threshold is exceeded the method proceeds to block 922 where an alert may be produced based upon the condition exceeded. For instance, the alert may include notifying personnel of a predicted system failure or a task which may need attended to. For instance, as described above, machine learning component 720 may receive information a drawer has been opened a number of times which exceeds a threshold indicating a galley is empty. For the galley to become restocked, the alert mechanism 760 alerts personnel so that the galley is restocked.

In some embodiments, at block 924, the machine learning component 720 stores aircraft analysis evaluation from block 912 for a user identified in block 902. In embodiments, storage 750, including stored aircraft analysis 752 and user profile 754, is specific to a user and includes historical data such as environment parameters, movements in the cabin, and interactions with any cabin components such as gallies, seats, or vanities which are detected by sensors 200 while the user is in the automated environment 20. Stored aircraft analysis 752 includes usage patterns, identified preferences, and additional user inputs all of which may be stored in database/storage 750 which may include a wireless/cloud-based server or local non-transitory computer memory onboard the aircraft or at an outside location to provide real-time feedback.

With reference to FIG. 10, a flow diagram is provided illustrating a method carried out by machine learning component 720. Each block of the method 1000 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media.

FIG. 10 illustrates a method 1000 of a series of acts in a method of automated management of an aircraft, in accordance with embodiments of the present disclosure. In one or more embodiments, the method 1000 is performed in an environment that includes the automated cabin environment 20. In some examples, the method 1000 may be performed by a computing device such as the one of the computing device 1200, described with reference to FIG. 12. The method 1000 is intended to be illustrative of one or more methods in accordance with the present disclosure and is not intended to limit potential embodiments. Alternative embodiments can include additional, fewer, or different steps than those articulated in FIG. 10.

At block 1002 the method begins.

At block 1004, the machine learning component 720 identifies a user. A user may be identified when accessing the network of the automated automated aircraft management system 700. In embodiments, the network of the automated aircraft management system 700 may be accessed using Wi-Fi, Bluetooth, or NFC as described above. A user may access the network in some implementations using a smartphone, or another type of device having a display with a user interface. In embodiments, user identification can be accomplished using an RFID module. A user may be identified based upon the device they are accessing the network on, or by signing into a personalized account which may be recorded in input module 710.

At block 1007, the machine learning component 720 determines if sufficient historical data (in storage 750) exists for an identified user. The neural network model 130 of FIG. 8 may be input with a user profile 754 including historical data such as a stored aircraft analysis 752. Historical data is created when the sensors 200 disposed in the automated cabin environment 20 detect an environment and user actions or activities. For example, a user may set a preferable cabin temperature which may be detected by temperature sensors, stored in storage 750, and added to the user profile 754. Additionally, other sensors such as contact and strain sensors may be incorporated into gallies and vanities in the cabin to detect how a vanity or galley is being used by a user. In embodiments, the machine learning component 720 may determine a sufficient amount of historical data exists when the neural network model 130 is able to predict with a specified accuracy whether or not a user will perform an action or input a setting.

In some instances, storage 750 may have insufficient data for the 720 to reference for a user accessing the network. The historical data in storage 750 may be insufficient if it is a user's first time accessing the automated aircraft management system 700 network, or if the user has not accessed the network a sufficient number of times (i.e. more than one time) for the machine learning component 720 to have established a reliable history for the user.

If the machine learning component 720 determines sufficient historical data exists in storage 750 at block 1007 the method 1000 proceeds to block 1008. In block 1008, the adjustment component 740 adjusts the cabin environment based on the stored aircraft analysis 752 data and the user profile 754. For instance, as stated above, historical data may include information about a desired cabin temperature and lighting as well as an aircraft seat position which may be customized based on activity or manual adjustment of a user. In embodiments, the customization of the cabin environment may be accomplished using the neural network model 130 outputting the aircraft analysis 730 providing adjustments (FIG. 8). In some embodiments, the adjustment component 740 applies adjustments to mechanisms which may include controlling window shades as well as electrical lighting to set the lighting of a cabin to a desired level. In some embodiments, the machine learning component 720, based off historical data in a user profile 754, predicts cabin settings that may be desired by a specific user.

At block 1010, the machine learning component 720 provides continuous adjust for the automated environment 20 while adding additional sensor data and user inputs into the user profile 754. The detection component is configured to detect when a user triggers a sensor, and when a sensor is triggered, the machine learning component 720 stores information gathered from the sensors 200 to add to storage 750 including historical data of the user. For instance, if a user utilizes the galley or vanity, the sensors 200 disposed on the galley or vanity will detect the presence and activity of the user and transmit the usage data to the machine learning component 720 for contribution to the user profile 754. Having more historical data in a user profile 754 may substantially increase the accuracy of the machine learning component 720 in predicting the next actions and patterns of a user.

If in block 1007 insufficient historical data exists in a user profile, the method 1000 proceeds to a block 1012. In block 1012, the machine learning component 720 applies default settings to the automated cabin environment 20. Default settings may be preloaded to the machine learning component 720 and based off standard environment and entertainment settings for an aircraft cabin.

At block 1014, the machine learning model to applies machine learning and other calculation to add historical data to a user profile. The machine learning component 720 is transmitted information from the input module 710 including the detection component employing sensors 200 which are disposed throughout the aircraft cabin to detect aircraft parameters and activities of a user. The machine learning model, in embodiments neural network model 130, stores the data received from the detection component in the user profile such that a customized cabin environment may be available when sufficient historical data exists.

Continuing from blocks 1010 and 1014, the method 1000 proceeds to block 1016. At block 1016, the machine learning component 720 determines if an anomaly has been detected. The machine learning component 720 may analyze an aircraft analysis 730 as shown and described above in relation to FIG. 9 to determine if an anomaly has been detected. In embodiments, examples of anomalies may be detecting an abnormal reading from the detection component, or detecting that a condition has been met a number of times. The machine learning component 720 uses information from the input module 710 including the detection component and sensors 200 to detect anomalies. For instance, if a momentary micro switch is configured to detect the number of times a drawer is opened and a strain sensor determines the amount of weight displaced from a drawer, the machine learning component 720 may be able detect when the drawer will be emptied based off the usage of a user. In another instance if a contact sensor is configured to detect how often a user sits in an aircraft seat, the machine learning component 720 may receive a detection when the seat is used (i.e. a condition) and set a conditional threshold to determine when the seat will need replaced. An anomaly will be detected when the condition exceeds the threshold limit. In embodiments, the machine learning component 720 uses the neural network model 130 (FIG. 8) to detect anomalies. In another instance, sensors 200 may detect the usage of a galley drawer or an aircraft air conditioning system and the machine learning component 720 will be configured to use the neural network model 130 to detect an anomaly providing indication when the drawer needs restocked or air conditioning system needs maintenance based off a user usage pattern.

At block 1018, the alert mechanism 760 produces an alert if an anomaly is detected. If an anomaly is not detected at block 1016 the process returns to start block 1002. An example of an alert may be to alert personal completion of a task is required which may be any of replacing an aircraft seat, restocking a galley, or a preemptive notification about a malfunctioning system. The machine learning component 720 uses the input module 710 including the detection component and sensors 200 as described above to predict when aircraft components and systems may need attention. After block 1018, method 1000 returns to the start block 1002.

### Example Use Case Sequence Diagram

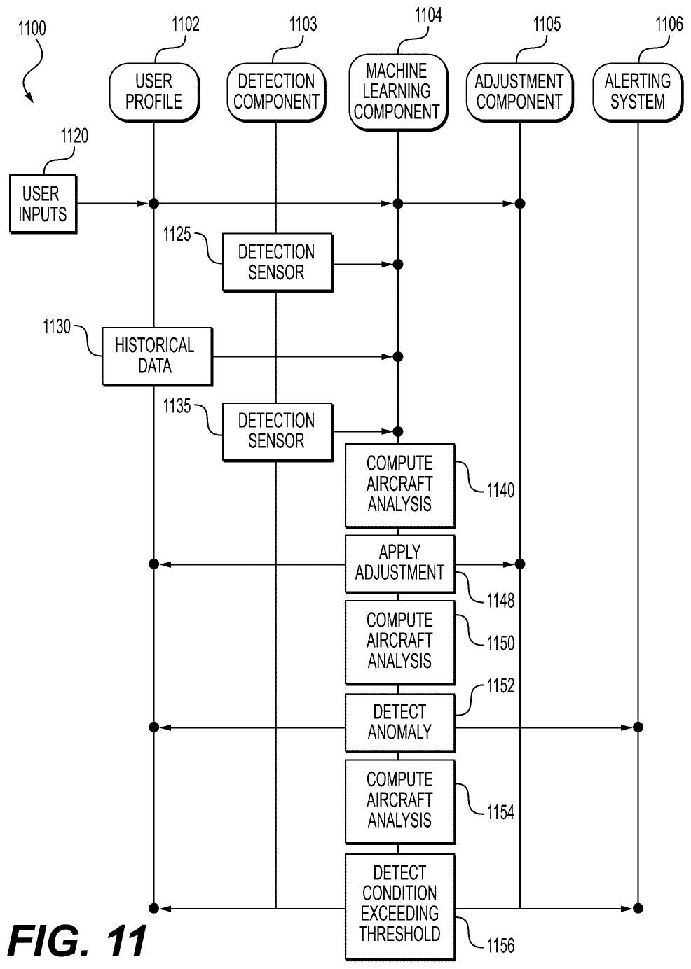

FIG. 11 shows a sequence diagram 1100 of an example use case scenario of a system creating automated aircraft management, respectively, in accordance with embodiments of the present disclosure. According to some aspects, the sequence diagram 1100 represents a procedure that can occur to components within an automated aircraft cabin environment to allow them to exchange information, analyze an aircraft, and implement the output adjustments. The implemented adjustments create a customized environment for a user in the automated cabin environment which does not require direct human monitoring or intervention. Additionally, in some aspects, the sequence diagram 1100 illustrates how AOG time can be decreased by providing notification to personnel of preemptive failure points of aircraft systems and components. Additionally, the sequence diagram 1100 illustrates that separate and distinct adjustments can be implemented within the automated cabin environment.

As shown, the sequence diagram 1100 includes a machine learning component 1104 capable of receiving inputs from detection component 1103 and user profile 1102 and outputting commands to adjustment component 1105 and alerting system 1106. In embodiments, user profile 1102 can include historical data at block 1130 which is input into machine learning component 1104. In some embodiments, user inputs at block 1120 are input into user profile 1102, machine learning component 1104, and adjustment component 1105. In embodiments, user inputs at block 1120 can include a user associated with user profile 1102 adjusting a cabin setting such as temperature, lighting, entertainment, or seat position.

In some embodiments, detection component 1103 includes detection sensor 1125 and detection sensor 1135. In some embodiments, sensors 1125 and 1135 can detect environmental parameters and user activities. Sensor 1125 and sensor 1135 each communicate with several components of an automated aircraft management system environment. These components include a detection component 1103, machine learning component 1104, adjustment component 1105, and an alerting system 1106. While only two sensors (1125, 1135) are shown in FIG. 11, implementations of the present disclosure can include any number of sensors capable of detecting parameters in an aircraft.

In some examples, at block 1125, the sensor detects an environmental parameter associated with the automated cabin environment. The sensor can be a temperature, humidity, or lighting detection instrument any of which may be disposed in the cabin environment. The sensor 1125 can communicate with the detection component 1103 and machine learning component 1104.

In a similar fashion as block 1125, the detection component 1103 includes a sensor at block 1135. As discussed, the detection component 1103 can implement various sensors which may detect user activities in the automated environment which may be the aircraft cabin. These sensors, as discussed above may be contact sensors, motion sensors, and pressure sensors. More specifically, these sensors may be atmospheric sensors, radiation sensors, touch sensors, and possibly cameras. The sensor data at block 1135 is provided to the machine learning component 1104.

In some embodiments, user inputs at block 1120 are received by machine learning component 1104, user profile 1102, and adjustment component 1105. In some embodiments, user inputs at block 1120 can be a user manually adjusting mechanisms controlling cabin parameters possibly using a human machine interface.

As an example, at block 1130, the machine learning component 1104 receives historical data. The historical data provides the machine learning component 1104 with information about past user settings and user activities within the automated environment. The machine learning component 1104 receives historical data from block 1130 while receiving information from the detection component 1103 and sensors 1125 and 1135 to compute an aircraft analysis and apply adjustments. The machine learning component 1104 adds the information from the sensors 1125 and 1135 and the detection component 1103 to storage 750 for reference.

At block 1140, machine learning component 1104 computes an aircraft analysis. The aircraft analysis can be based on the historical data and the information received from sensors 1125, 1135 and detection component 1103, as well as user inputs. The machine learning component 1104, in embodiments, is able to analyze the inputs using the neural network model 130, shown in FIG. 8. As an example, in this particular use case scenario, the aircraft analysis computed can be a customized automated cabin environment parameter, which may be an environmental or entertainment setting. The machine learning component 1104 is able to compute an adjustment based upon historical data in a user profile and the sensor data from the detection component of the cabin.

At block 1148, machine learning component 1104 applies adjustments to implement the aircraft analysis. The machine learning component 1104 is configured to communicate with and control adjustment component 1105 such that adjustments regarding the automated cabin environment can be implemented. In a particular instance, machine learning component 1104 can control an aircraft air supply system to adjust the temperature of the cabin to a temperature computed in the aircraft analysis.

At block 1150, the machine learning component 1104 computes an aircraft analysis using the inputs as described with block 1140.

At block 1152, machine learning component 1104 detects an anomaly. In some embodiments, an anomaly may be an abnormal detection from detection component 1103. An abnormal sensor detection may indicate faulty aircraft equipment, which can be a malfunctioning air supply, electrical, or entertainment system. The machine learning component 1104 communicates the anomaly to an alerting system 1106 such that an alert may be produced to notify personnel of a possibly malfunctioning system. The machine learning component 1104 may also communicate the anomaly to user profile 1102 to be added to historical data.

At block 1154, the machine learning component 1104 computes an aircraft analysis. The adjustment can be based on historical data and sensor data received from sensors 1125, 1135 and detection component 1103, similar to blocks 1150 and 1140. The machine learning component 1104 may be configured to detect when a condition is met a specified number of times which exceeds a threshold. In some embodiments, a condition may be when a drawer, cabinet, or cupboard is opened.

At block 1156, the machine learning component 1104 detects a condition has exceeded a threshold limit. As an example, in this particular use case scenario, a condition could be a drawer being opened. The machine learning component 1104 is able to determine if the drawer is empty, or determine when the drawer will need restocked based upon historical data and sensor data received from sensor 1125, 1135 and detection component 1103. In some embodiments, historical data provides indication to how often and the rate at which a user uses the drawer to predict a time when the drawer will need restocked. In this particular scenario, machine learning component 1104 communicates with alerting system 1106 to produce an alert which notifies personnel to restock the drawer, which may include the particular drawer that needs restocked and the item(s) that the drawer contains.

As described in FIG. 11, the machine learning component 1104 can facilitate the automated monitoring and management of an aircraft. In this example, the machine learning component 1104 facilitated the monitoring of the aircraft cabin and predicted three distinct adjustments without human intervention or interaction required.

### Example Operating Environment

Having described an overview of embodiments of the present technology, an example operating environment in which embodiments of the present technology may be implemented is described in order to provide a general context for various aspects of the present technology. Referring now to FIG. 12, in particular, an exemplary operating environment for implementing embodiments of the present technology is shown and designated generally as computing device 1200. Computing device 1200 is but one example of a suitable computing environment and is not intended to suggest any limitation as to the scope of use or functionality of the technology. Neither should computing device 1200 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 12, computing device 1200 includes bus 1210 that directly or indirectly couples the following devices: memory 1212, one or more processors 1214, one or more presentation components 1216, input/output ports 1218, input/output components 1220, and illustrative power supply 1222. Bus 1210 represents what may be one or more buses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 12 merely illustrates an example computing device that can be used in connection with one or more embodiments of the present technology. A distinction is not made between such categories as “workstation,” “server,” “laptop,” “handheld device,” etc., as all are contemplated within the scope of FIG. 12 and reference to “computing device.”

Computing device 1200 typically includes a variety of computer-readable media. Computer-readable media can be any available media that can be accessed by computing device 1200 and includes both volatile and nonvolatile media, removable and non-removable media. By way of example, and not limitation, computer-readable media may comprise computer storage media and communication media.

Computer storage media can include volatile and nonvolatile, removable, and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1200. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1212 includes computer storage media in the form of volatile or nonvolatile memory. The memory may be removable, non-removable, or a combination thereof. Examples of hardware devices include solid-state memory, hard drives, optical-disc drives, etc. Computing device 1200 includes one or more processors that read data from various entities, such as memory 1212 or I/O components 1220. Presentation component(s) 1216 presents data indications to a user or other device. Examples of presentation components include a display device, speaker, printing component, vibrating component, etc.

I/O ports 1218 allow computing device 1200 to be logically coupled to other devices, including I/O components 1220, some of which may be built in. Illustrative components include a microphone, joystick, game pad, satellite dish, scanner, printer, wireless device, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for automated aircraft management, the method comprising:
collecting sensor data from sensors associated with an aircraft;
inputting information including the sensor data into a machine learning model for analysis;
outputting, via the machine learning model, an aircraft analysis associated with the sensor data and the aircraft, where the aircraft analysis includes adjustments to mechanisms within the aircraft; and
applying, at least in part, the adjustments from the aircraft analysis to the aircraft.

2. The method of claim 1, wherein the machine learning model is a neural network.

3. The method of claim 1, wherein the adjustments include adjustments to environmental conditions within an aircraft cabin of the aircraft.

4. The method of claim 1, further comprising:
receiving user input from within an aircraft cabin of the aircraft; and
combining the user input into the information including the sensor data prior to inputting the information into the machine learning model.

5. The method of claim 4 wherein the user input adjusts a component in the aircraft cabin.

6. The method of claim 1, further comprising:
detecting, via at least one sensor from the sensors, an activity performed in an aircraft cabin of the aircraft; and
combining the activity into the information including the sensor data prior to inputting the information into the machine learning model.

7. The method of claim 6 wherein the activity is an individual using an aircraft cabin component.

8. The method of claim 1, further comprising:
analyzing the aircraft analysis produced by the machine learning model;
detecting an anomaly associated with a component of the aircraft; and
producing an alert associated with the anomaly, wherein the alert includes data associated with the component.

9. The method of claim 8, wherein the anomaly includes indicators of faulty equipment within the aircraft.

10. The method of claim 1, further comprising:
analyzing the aircraft analysis produced by the machine learning model;
detecting a condition when the aircraft analysis has exceeded a predetermined threshold; and
producing an alert associated with the condition, wherein the condition includes data associated with an aircraft cabin of the aircraft.

11. The method of claim 10, wherein the condition is associated with items within an aircraft cabin of the aircraft.

12. The method of claim 8, wherein the alert provides notice to resupply an aircraft cabin component.

13. The method of claim 1, further comprising:
detecting, via at least one sensor from the sensors, an individual within an aircraft cabin of the aircraft;
retrieving a user profile associated with the individual, wherein the user profile includes historical data of user preferences; and
combining the historical data into the information including the sensor data prior to inputting the information into the machine learning model.

14. A system for automated aircraft management, the system comprising:
a detection component configured to detect parameters associated with an aircraft;
a machine learning component configured to provide an aircraft analysis of at least the parameters detected by the detection component; and
an adjustment component configured to adjust aircraft mechanisms associated with at least the aircraft analysis.

15. The system of claim 14 wherein a storage component stores the aircraft analysis in a profile.

16. The system of claim 14 wherein when the aircraft analysis includes an anomaly, providing an alert associated with the anomaly.

17. The system of claim 14 wherein the detection component include pressure, capacitive, temperature, and switch sensing instruments.

18. A computer program product for automated aircraft management, the computer program product comprising a computer readable storage medium having computer readable instructions stored therein, wherein the computer readable instructions, when executed on a computing device, causes the computing device to:
receive data associated with an aircraft, wherein the data includes sensor data from sensors associated with the aircraft;
analyzing the aircraft by inputting the data into a machine learning model, wherein analyzing the aircraft includes adjustments to aircraft mechanisms; and
implementing the adjustments to the aircraft.

19. The computer program product of claim 18 further comprising:
analyzing the aircraft inputting data into the machine learning model;
detecting an anomaly associated with a component of the aircraft; and
producing an alert associated with the anomaly, wherein the alert includes data associated with the component.

20. The computer program product of claim 18 further comprising receiving historical data from a user profile.
